(19) United States
(12) Patent Application Publication
(10) Pub. No.: US 2007/0244856 A1
(43) Pub. Date: Oct. 18, 2007

(54) Media Search Scope Expansion

(75) Inventors: Daniel Plastina, Sammamish, WA (US); Lukas C. Dudkowski, Seattle, WA (US); Michael J. Novak, Redmond, WA (US); Judson Craig Hally, Sammamish, WA (US); Asif M. Baki, Snoqualmie, WA (US); William Frederick Kiefer III, Seattle, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/279,870

(22) Filed: Apr. 14, 2006

(51) Int. Cl. G06F 17/30

(52) U.S. Cl. 707/3

(57) ABSTRACT

In response to the user query of a first data source, the first data source is search and search results, if any, are displayed. In addition, a second data source is searched using the same or a similar query and the results, if any, are displayed.

### BACKGROUND

In the realm of personal digital music, there are several interesting “scopes” or “libraries” of media. In the most personal space, there is a personal media collection. This collection is generally locally stored on one or more machines/devices. This is a very real scope; one that exists for hundreds of millions of users today. In the least personal space is the scope of all available media. A real-world approximation of this scope would amount to a regional retailer selling via the Internet, such as an online music store or a subscription service.

An interaction between these two scopes involves extracting media from one and inserting the extracted media into the other, particularly for users that like to buy/download. Many do. Another model is where the user considers both scopes to be part of “the user's library” and thus the music that comes out of the user's speakers is really sourced from either one.

All of the above cites music as an example but applies equally well to any form of digital media: Movies, TV Shows, Books on Tape.

The above two scopes are very, very different. This holds true for a multitude of reasons. The local scope has on average less that 2000 songs; available media via subscriptions is at around the 1.5 MM mark today with expectations of this easily reaching 5 MM and even 20 MM songs. Because the service library clearly eclipses the local library, the integration of the two has generally been seen as uninteresting to do. In addition, the rate of a user consuming media is relatively low when compared to the amount of media released during the same time period. This is to say that far more media is released on any given day that a single (normal) user would purchase and thus updating 100 MM clients “just in case” is generally seen as foolish/non-obvious. Thus, historical user interfaces, implementation models, etc are also very different.

### SUMMARY

Embodiments of the invention include a system and method for expanding the scope of a user search. In an embodiment, the invention includes receiving a query by a user with respect to one media source and applying the query to a second media source.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1A is an exemplary block diagram illustrating various sources available to a user.

FIG. 1B is a block diagram illustrating one example of a suitable computing system environment in which the invention may be implemented.

FIG. 1C is a flow diagram illustrating one embodiment of the invention and referencing FIGS. 1-23

FIGS. 1-23 are screen shots illustrating one embodiment of the invention.

Corresponding reference characters indicate corresponding parts throughout the drawings.

### DETAILED DESCRIPTION

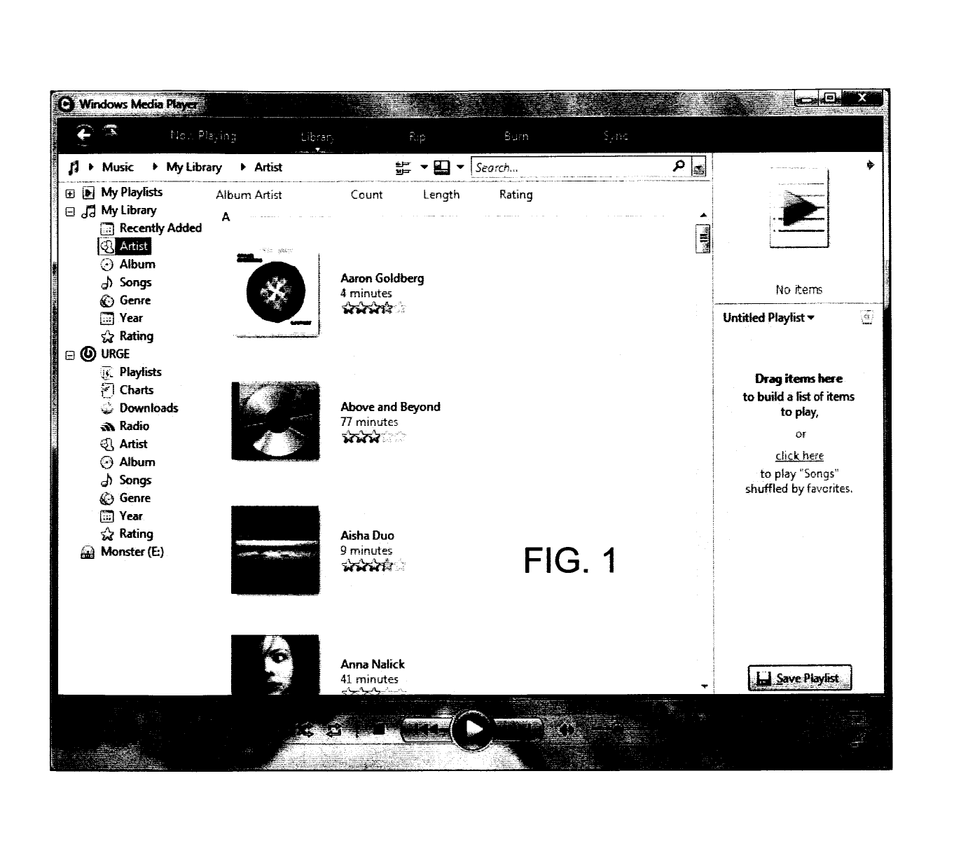

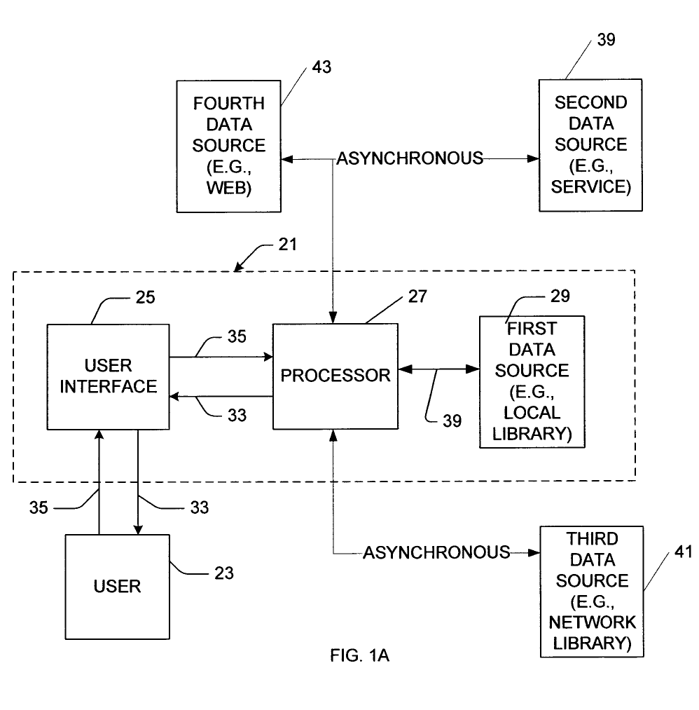

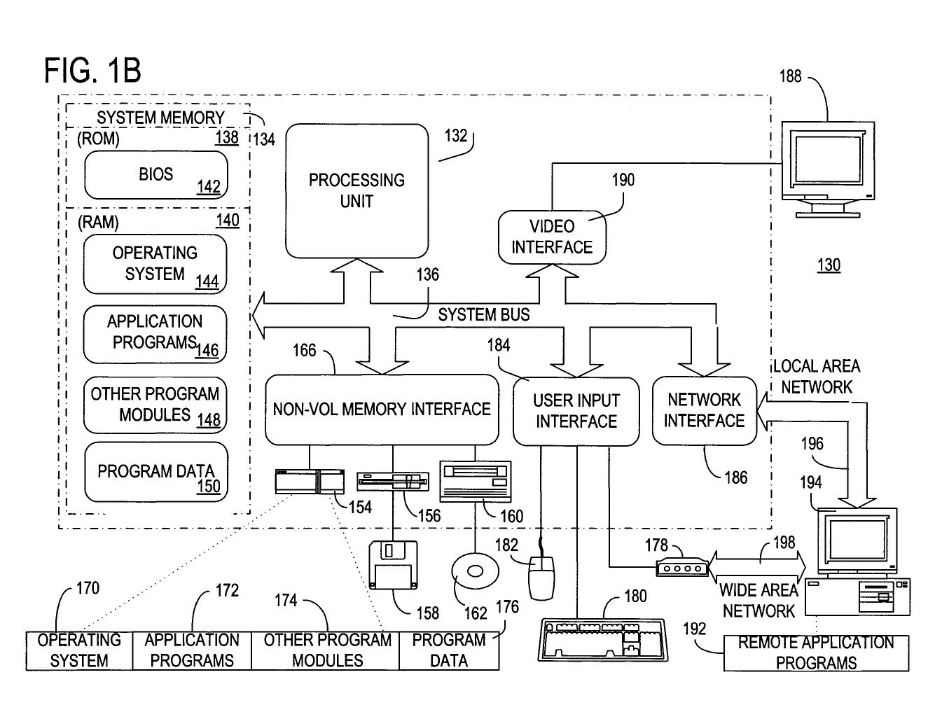

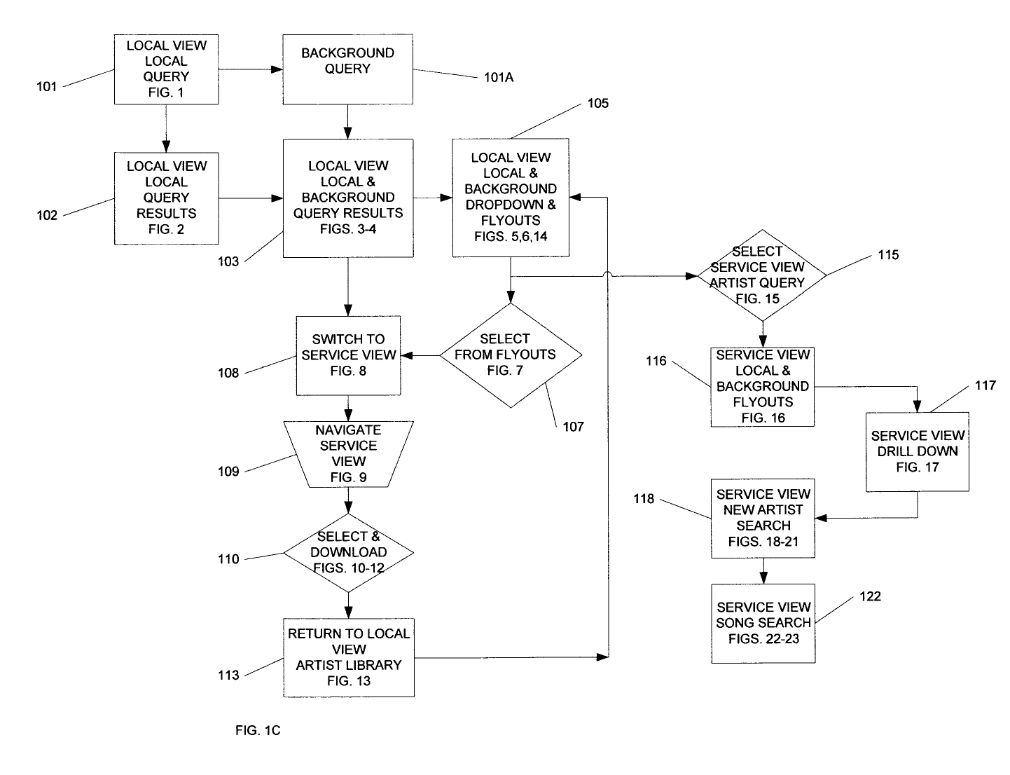

Referring now to FIG. 1A, a system, generally indicated at 21, is disclosed for facilitating a user 23 in generating a list of media items from a library of media items based upon a query. In one example, the user 23 may desire that the system collect desirable media items within a first data source 29 such as a local library. As used herein, the term media item comprises media files of multiple formats, including, music, speeches, audio books, news reports, movies, movie trailers, audio blogs, radio stations, television shows, images, and comedy routines, among others. In one example, the user 23 may utilize a media player program on a computer 130 (see FIG. 1B) to access the data source. An example of such a media player is the Windows® Media Player 11 by Microsoft Corporation of Redmond, Wash.

The system 21 depicted in FIG. 1A comprises several components, including a user interface 25, a processor 27, and the data source 29 containing the library of media items. The user interface 25 receives instructions 35 such as queries from the user 29 and provides information 33 such as query results to the user 23. In general, the system 21 has multiple data sources. In addition to local library 29, other source may be a second data source 39 such as a media service, a third data source 41 such as a library available via an internal or external network and a fourth data source 43 such as the Internet or other web.

In one embodiment, the media items contained in the local library 29 are defined by the user 23. Such a library 29 may be stored on a user's computer 130 (see FIG. 1B), a portable media playing device (e.g., an MP3 player), a storage device (e.g., a flash memory device), or virtually any other data source. In another example, a service provider maintains a large library as the second data source 39 of media items at a separate storage facility (e.g., a server) for streaming to the user 23 upon request and/or for addition to the user's local library 29. In yet another example, the library 29 may be defined by both a user's personal library 29 of media items and the media items in library 39 provided by a service provider. In any case, however, the library 29 acts as a repository for media items of potential of interest to the user 23. Such libraries of media items may be very large, containing many tens, hundreds, or thousands of media items.

The user interface 25 and the processor 27 of the system 21 are adapted for performing the actions described below with respect to the methods described herein. The processor receives 35 instructions and selections from the user 23 through the user interface 25. The processor 27 provides information 33 to the user 23 through the user interface 25. The processor 27 communicates 39 with the data source 29 to access candidate media items. The detailed operation of the system 21 will be described in greater detail below with respect to the methods of the described herein.

In one embodiment, a computer-implemented method of operation on a data processing device such as the system 21 is described. The device has access to a first data source 29 of media items and has access to a plurality of additional data sources 39, 41, 43 of media items. The method generates in response to a first user query of the first data source 29 a first list of media items, if any, from the first data source which first list corresponds to the requirements of the first query. In addition, in response to the first user query of the first data source, at least one of the plurality of additional data sources is searched and information identifying one or more items, if any, found in the searching is displayed. The identified and displayed items of the searched data source correspond to the first user query. In this way, the scope of the user's search has been seamlessly expanded and the user understands the first list of media items belongs to the user and, in contrast, that the second list is available to the user, such as by renting/buying. However, the user is not confused up by such a user interface as the user go back and forth across the scopes (e.g., across the sources).

In the embodiment, the user experience can roam with the user as they use different devices and the user has the ability to experience music on given device and enjoy a similar experience on other devices in the home (HME) or on remote PCs (roaming awareness). This is not just being able to play a given artist on any PC, but rather experiencing owned personal playlists that were made on one PC (even referencing local content) on another PC with no PC-to-PC network connectivity. Such searching is content driven and provides access to very complex databases/data sources (internet wide community rating, song sales trends) with rich user experience constructs: word-wheel, search, sort, large list scrolling, alternate views, context menus, etc and with local storage for offline use.

In one embodiment, the first data source 29 may be a local library and the second data source 39, 41, 43 may be at least one of the following: a media service, a network library or an Internet accessible library. In this embodiment, the user experience would be as follows:

“When I, the user, search locally:

And I get local hits, then

I have the ability to see service results.

I have the ability to see home network library results.

I have the ability to see web results.

And I get no local hits, then

I have the ability to see service results.

I have the ability to see home network library results.

I have the ability to see web results.”

In one embodiment, the first data source 29 may be one of the following: a local library, a media service, a network library or an Internet accessible library and the second data source may be at least one of the following other than the first data source: a local library, a media service, a network library or an Internet accessible library. In this embodiment, the user experience would be as follows:

“When I, the user, search from another scope (service, other PC in home, etc.)

And I get local hits, then

I have the ability to see service results.

I have the ability to see home network library results.

I have the ability to see web results.

And I get no local hits, then

I have the ability to see service results.

I have the ability to see home network library results.

I have the ability to see web results.”

In one embodiment, the searching of the second data source is asynchronous relative to the searching of the at least one of the plurality of additional data sources. In this embodiment, the search results are provided asynchronously so that the searching performance of the first data source from the user perspective is not delayed and a user is not blocked from taking immediate action.

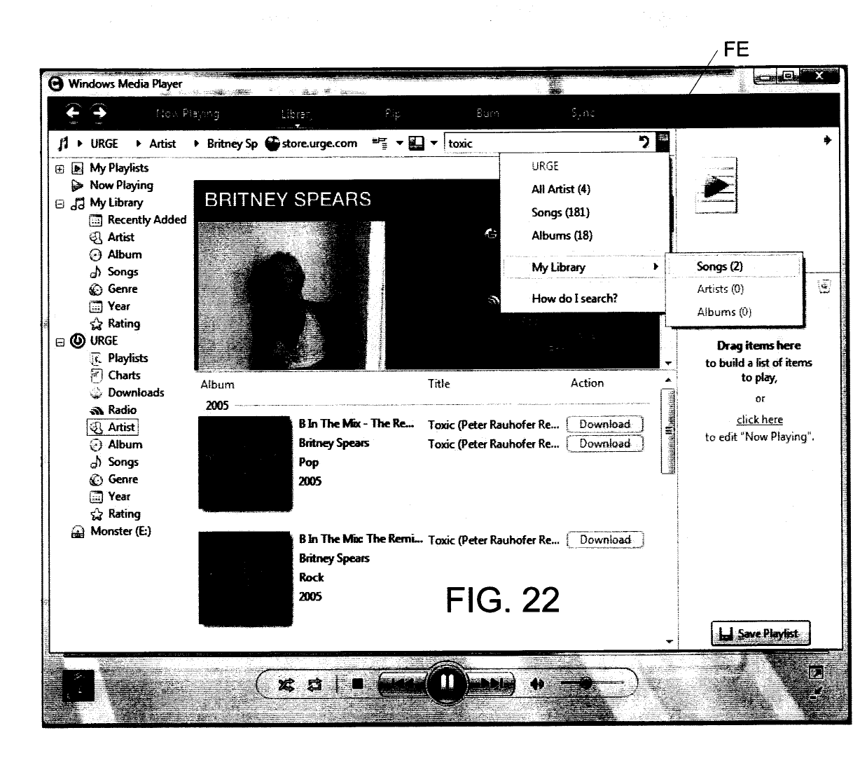

In one embodiment, a notifier is provided for indicating to the user that at least one item of the second data source has been identified as corresponding to the query for the first data source. For example, a “throbbing notifier” such as a flashing element FE is provided (see FIG. 22) when search results exist and the user needs a hint that maybe the user has searched within the wrong scope. For example, the user searches for “Artist H” and goes into the “Artist H” artist folder. If the user then Searches for “Artist K” but there is an Artist H Song that has “Artist K” in the title, thus there is a feedback mechanism that suggests that the user has searched the wrong scope.

In one embodiment, if the searching of the first data source yields no items, this suggests that the user may be in the wrong scope. Thus, the user is provided with the optional results of the search from the second data source. In this embodiment, the user experience would be as follows: “When I search<from any scope>but am in the wrong scope I get offered results.” For example, suppose the user searches for “Artist A” and goes into the “Artist A” folder. Then, suppose the user searches incorrectly for “Artist B” while in the Artist A folder, this embodiment give the user the option to go to the “Artist B” folder in an obvious way.

Thus, FIG. 1 illustrates a system for generating a list of media items. The system has access to the first data source 29 of media items and the second data source (39, 41 or 43) of media items. The user interface 25 receives the user query 35 for media items available from the first data source 29 and processor 27 generates a first list of media items via 33, if any, from the first data source 29 in response to the user query 35. The user interface 25 displays the first list of items via 33, if any, of the first data source. In addition, the processor 27 generates a second list of media items via 33, if any, from the second data source in response to the user query 35 and the user interface displaying the second list of items, if any, of the second data source.

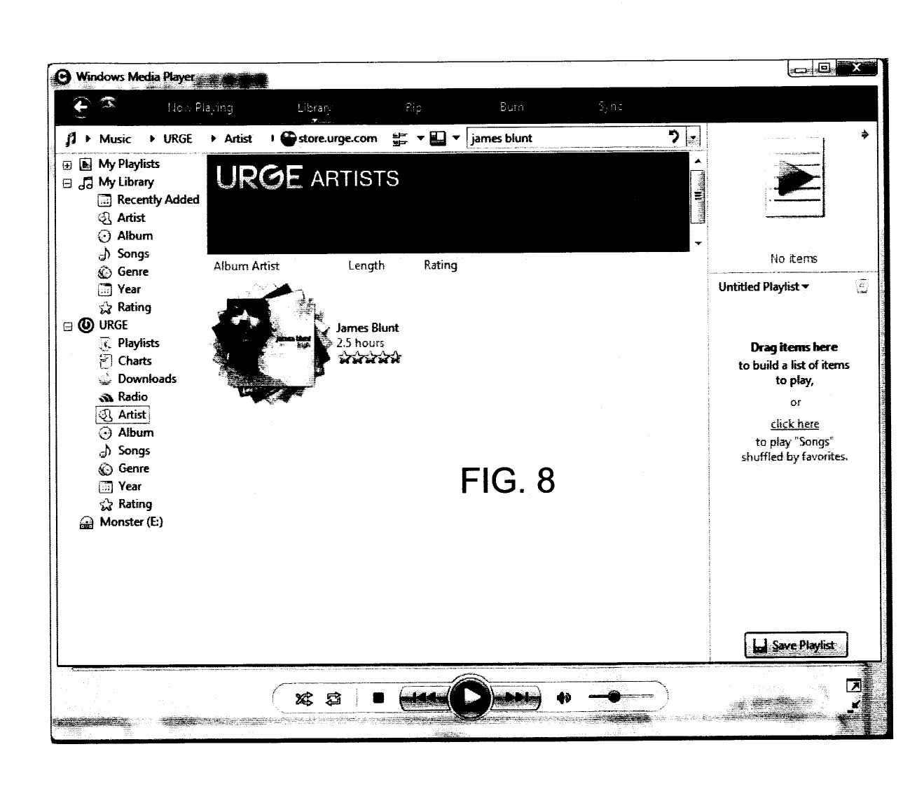

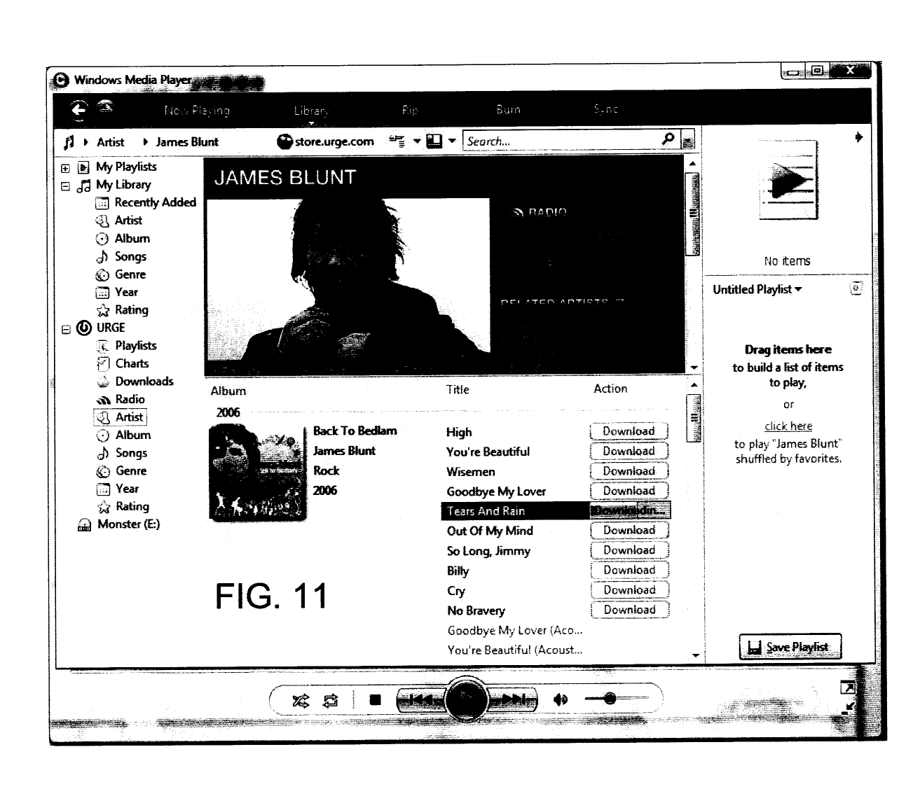

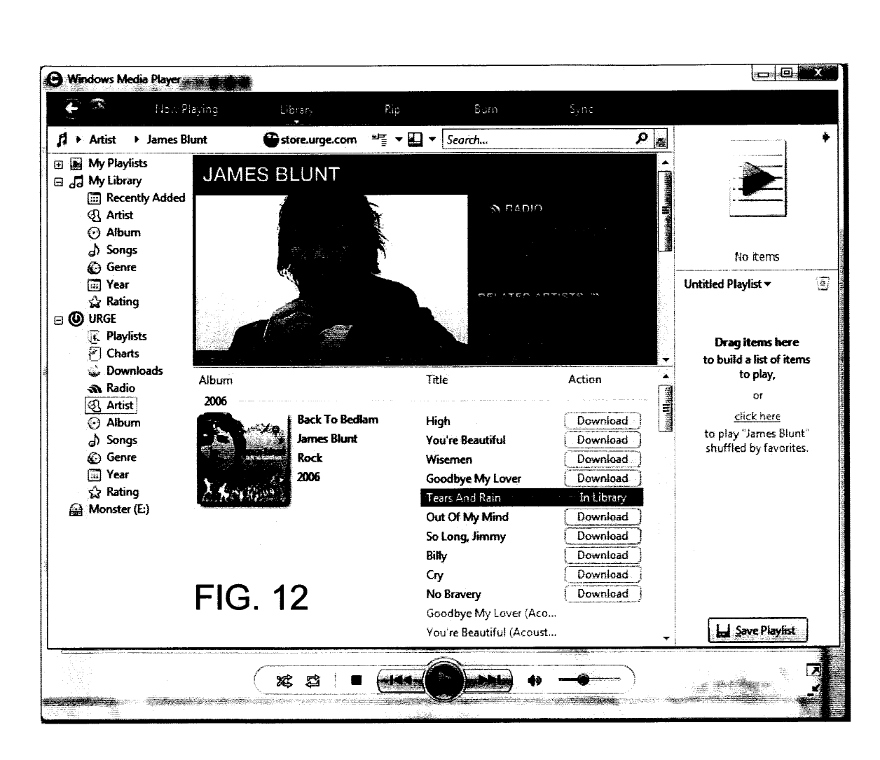

Referring to FIGS. 1-23 and as summarized in FIG. 1C, a user experience flow is illustrated describing the behavior for one embodiment of search scope expansion in a media player such as Windows® Media Player.

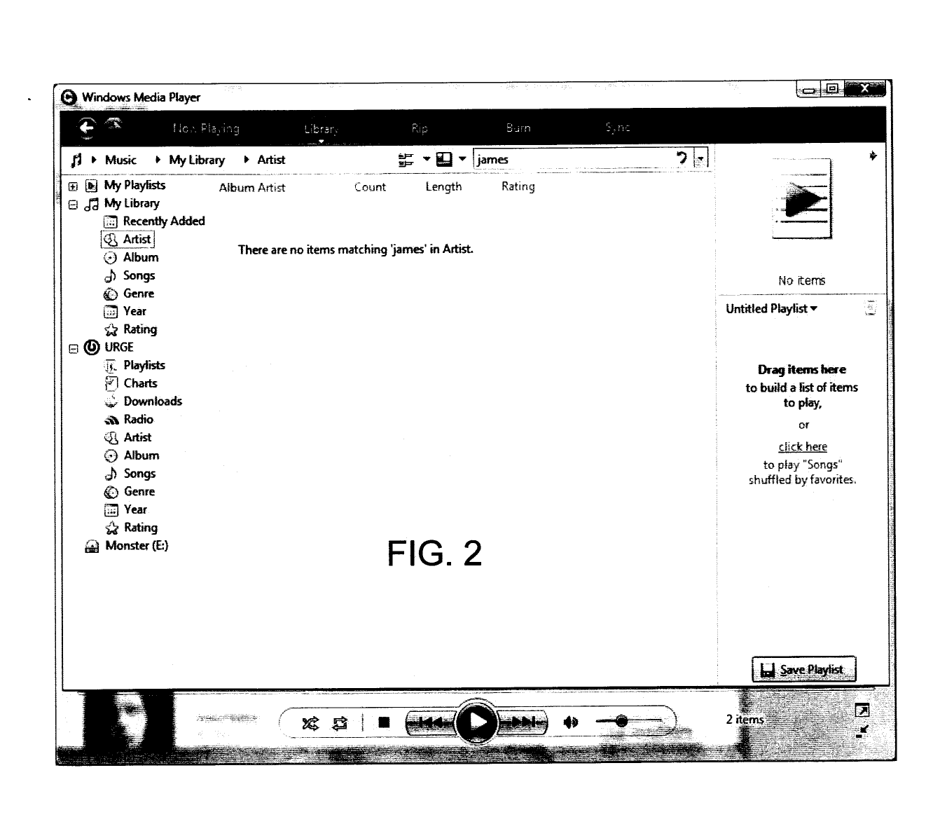

As shown in FIG. 1 and reference character 101 of FIG. 1C, the user 23 begins in an local view such as an artist view of the local content library 29 and selects the “word wheel” search control to conduct a local query. As the user begins typing the search query in the word wheel control, the view filters out the non-relevant results. In this case, the query “james blunt” produces at 102 of FIG. 1C no results in the local library as illustrated in FIG. 2 so that a “no results” message is conveyed to the user.

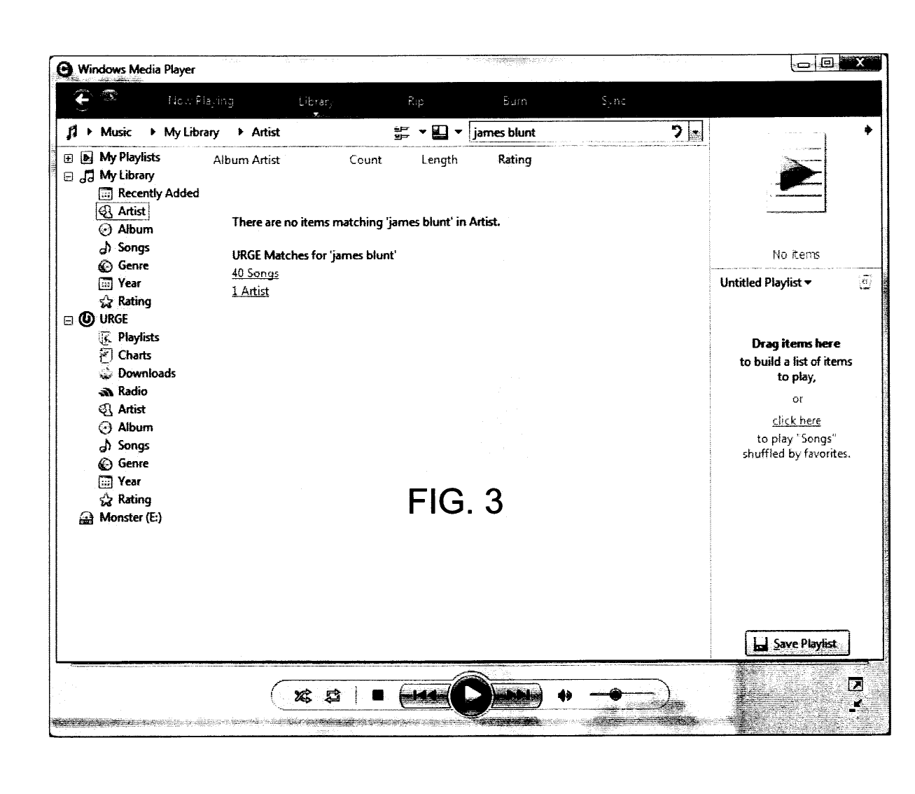

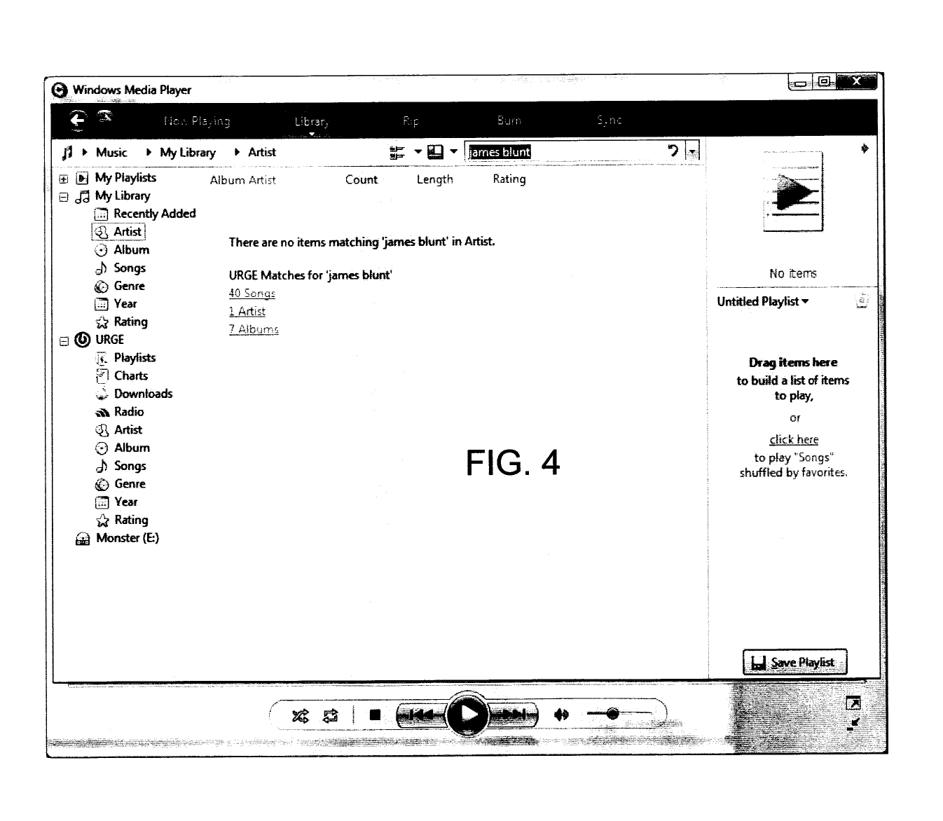

Almost simultaneously with the user launching the local query at 101, a background query on other library scopes 39, 41 and/or 43 is executed at 101A. In this case, the outside search scope is the Urge music service catalog. As the background query produces results, they are displayed asynchronously inline with the “no results” page as illustrated in FIGS. 3 and 4 and by reference character 103 in FIG. 1C. The results are displayed as hyperlinks that are actionable to the user. Clicking on a resulting hyperlink will cause the user to navigate to a view containing that particular query results for a particular scope.

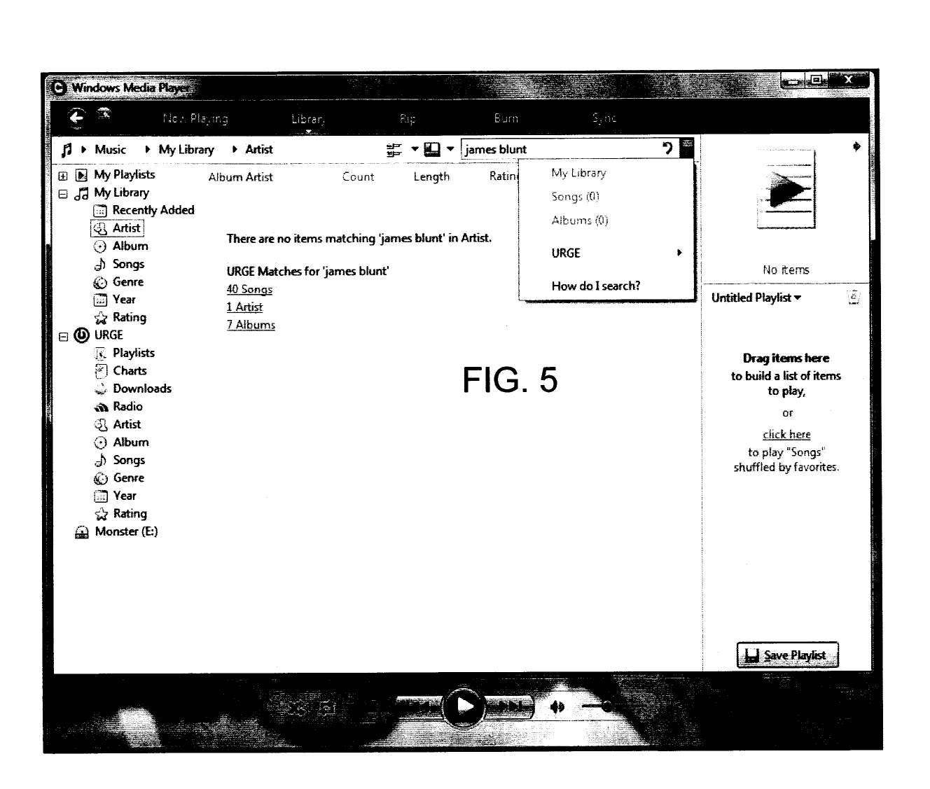

In addition to being available inline in the listview, the local and expanded query results are available via the Search control dropdown menu as shown in FIG. 5 and as indicated by reference character 105 in FIG. 1C. This menu of background query results is available regardless of whether the user has actually found any local items matching the query, that is, it is not dependent on the “no results” view. The user's current scope (in this case, the Local library) appears at the top of the dropdown menu, with the results from N additional search scopes available as fly-out menu items below (in this case, the Urge service results.)

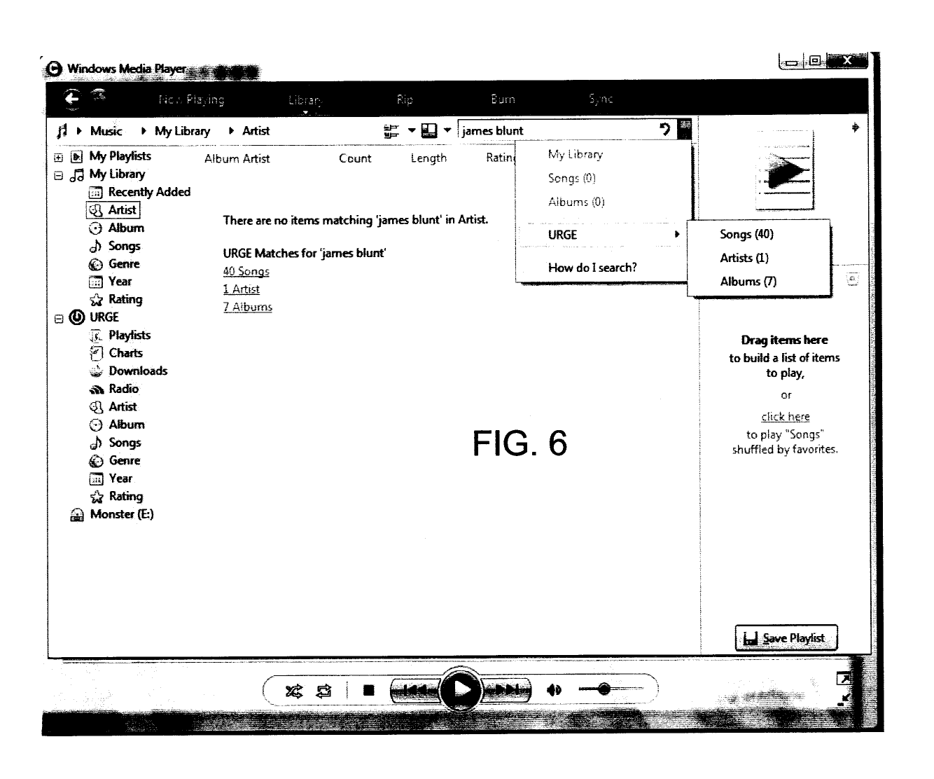

As shown in FIG. 6, clicking on the fly-out menu item for an expanded scope search allows the user to switch their current view in much the same way as through the links on the “no results page.” In this case, the results from the Urge catalog as shown with the associated number of results per given category (Songs, Artists, Albums matching the query)

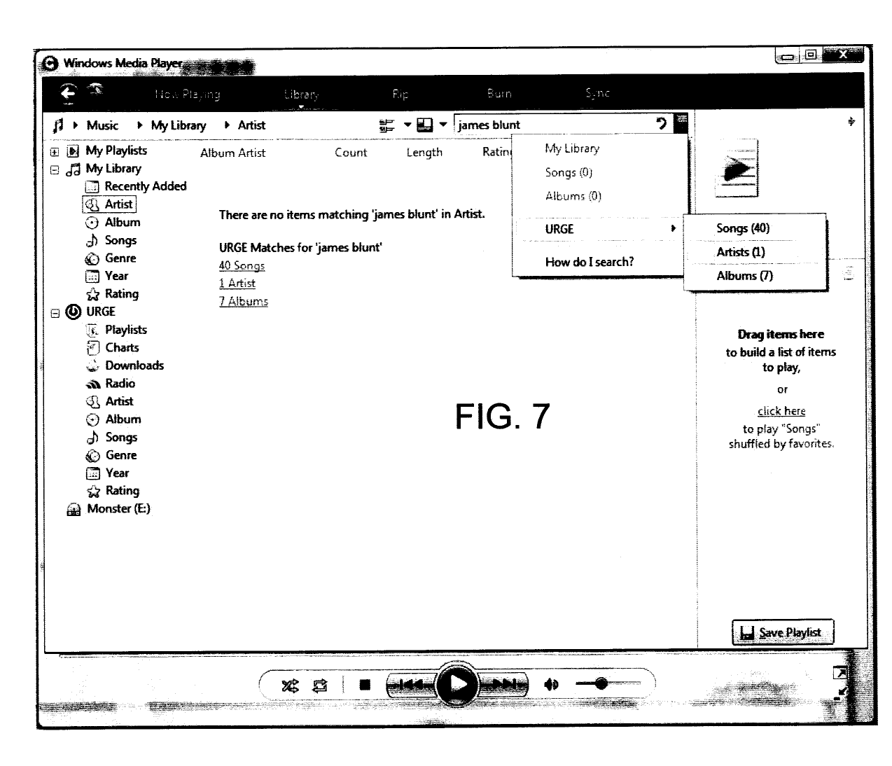

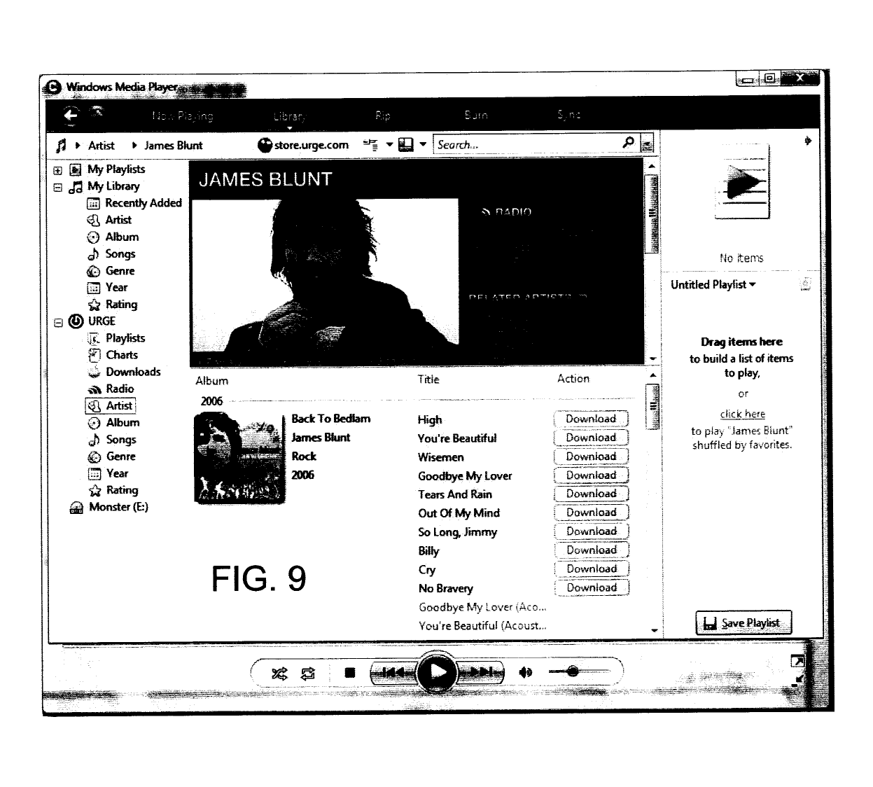

At 107 of FIG. 1C, the user is able to select one of the fly-out result links (in this case, the Artist match) to navigate to that view. This is illustrated in FIG. 7. Upon clicking on the results link (in this case, the one Artist category match for the query “james blunt”), the Library focus is switched to the Urge music service catalog, viewed by Artist, filtered by “james blunt,” as shown in FIG. 1B and illustrated at 108 of FIG. 1C. At 109, the user is then able to navigate into the Artist's “page” showing their content, illustrated in FIG. 9.

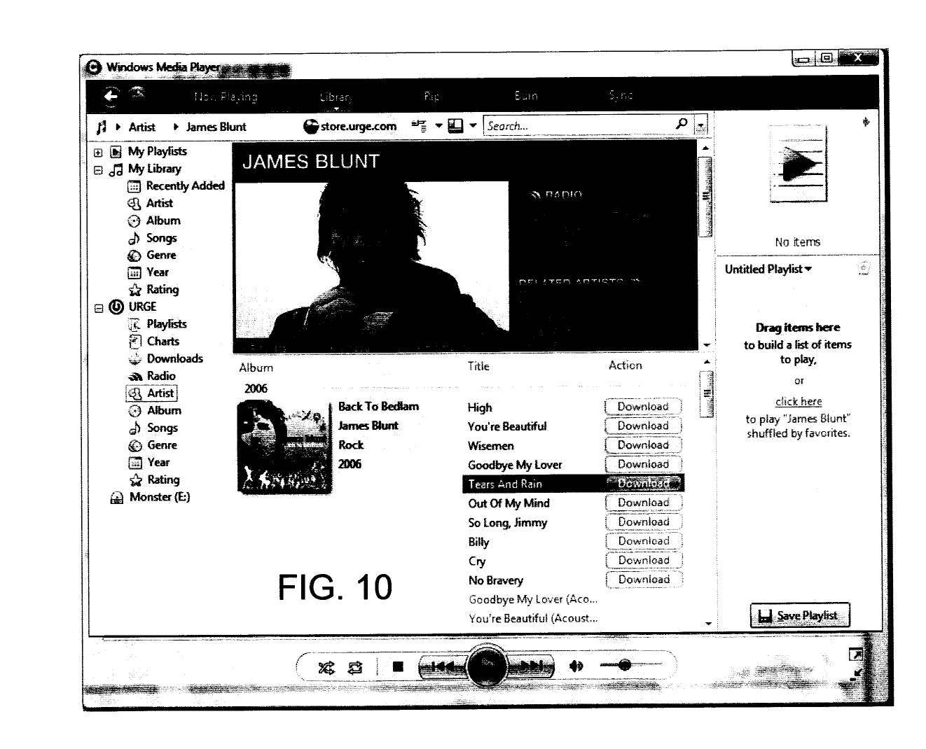

As indicated above in FIG. 2 and 102 of FIG. 1C, the user has no local content matching “james blunt.” For the purposes of this flow, as illustrated in FIGS. 10-12 and at 110 of FIG. 1C, the user elects the song title “Tears and Rain” and selects it for download to the local library. The content is then downloaded, and added to the User's local library.

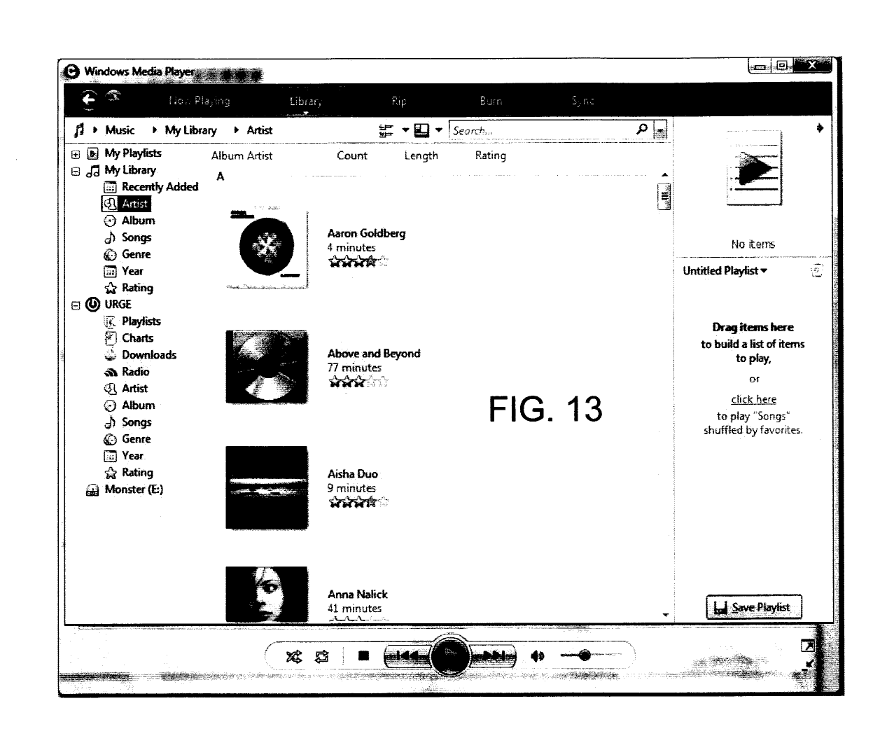

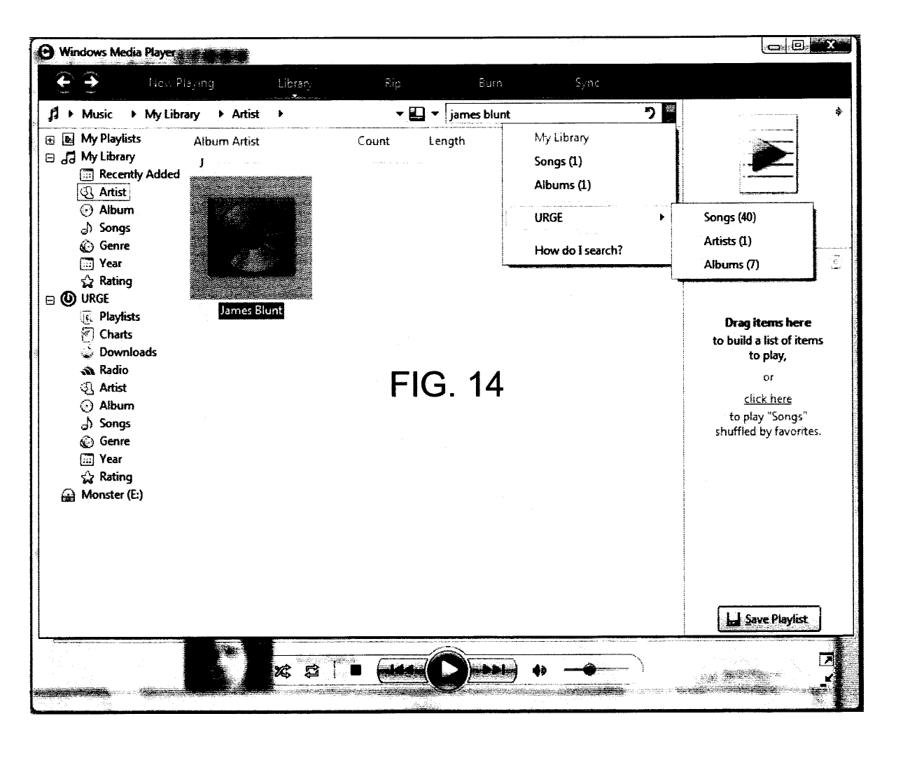

If the user at some later time chose to re-execute the flow shown in FIG. 1 with a local query, that is, start in a Local library view of “Artists” and search for “james blunt,” the query results would return the one song that the user downloaded locally by this particular artist. As noted above in FIG. 5, the search control dropdown menu also reflects the results of searches on outside scopes. In this case as shown in FIGS. 13 and 14, the user's current scope (local library) shows the single result of the previously downloaded track, but additionally the Urge fly-out menu item shows once again the Urge service results matching the “james blunt” query.

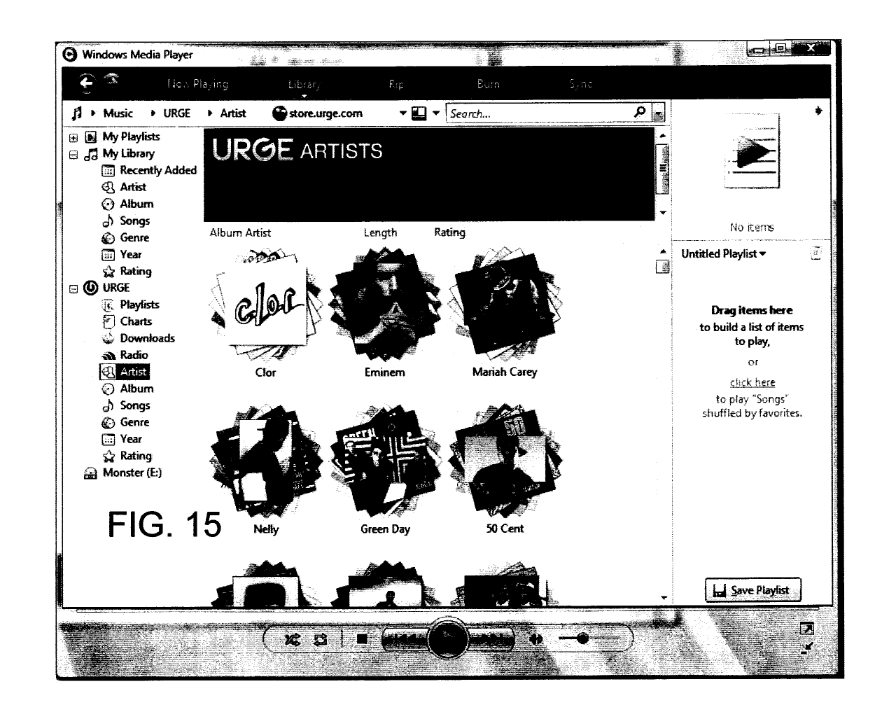

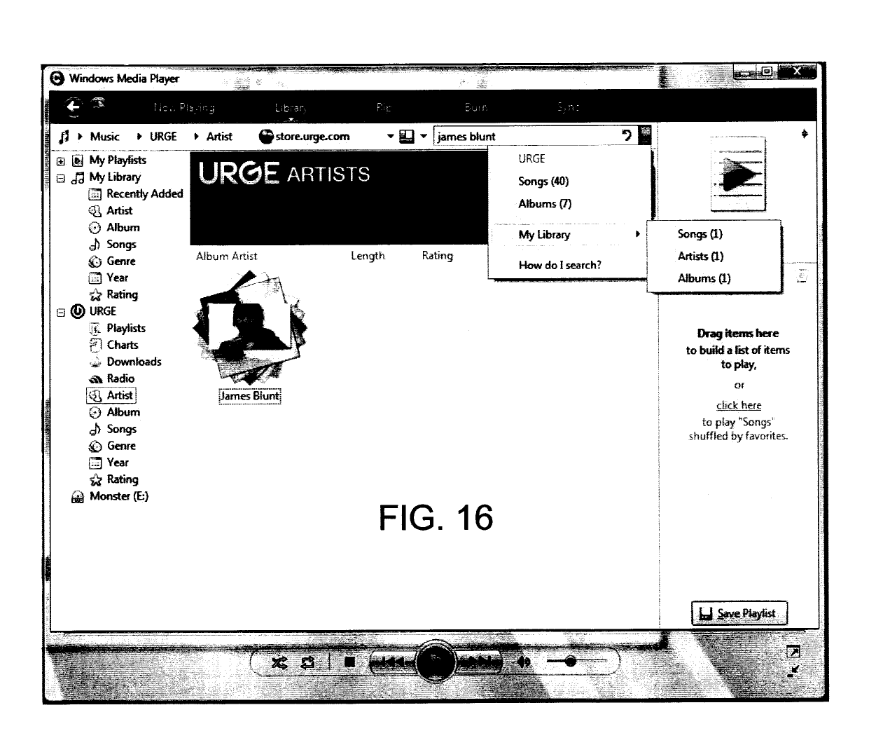

Conversely, if the user were to begin in an unfiltered view of Artists in the Urge service catalog and execute a query through the Search control for “james blunt”, as illustrated in FIGS. 15 and 16 and at 115 and 116 of FIG. 1C, the user would be able to use the drop-down menu to see the results of the current scope (the Urge service catalog) and the outside scopes (their local library).

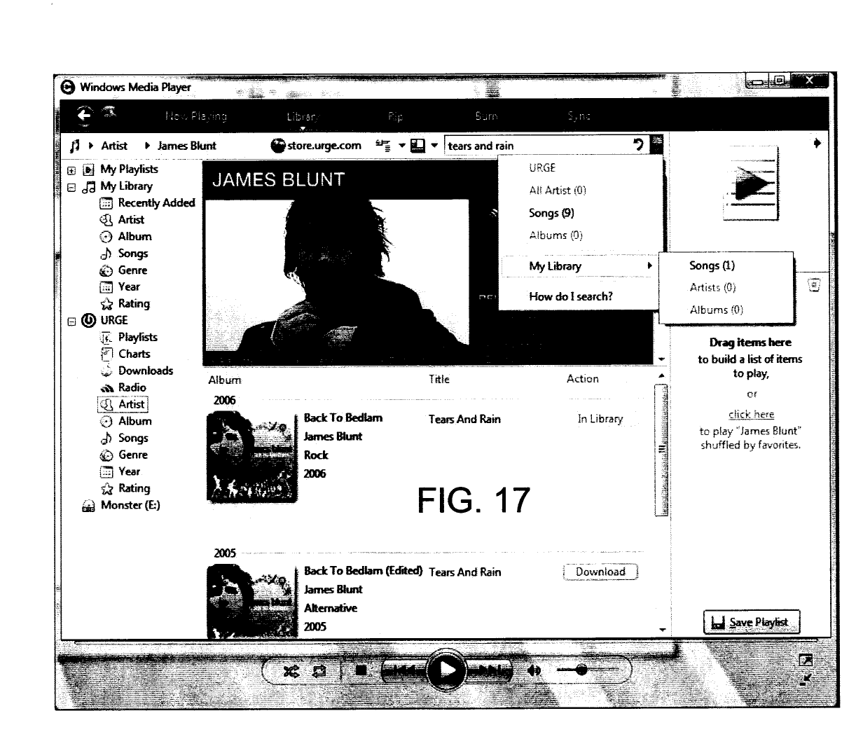

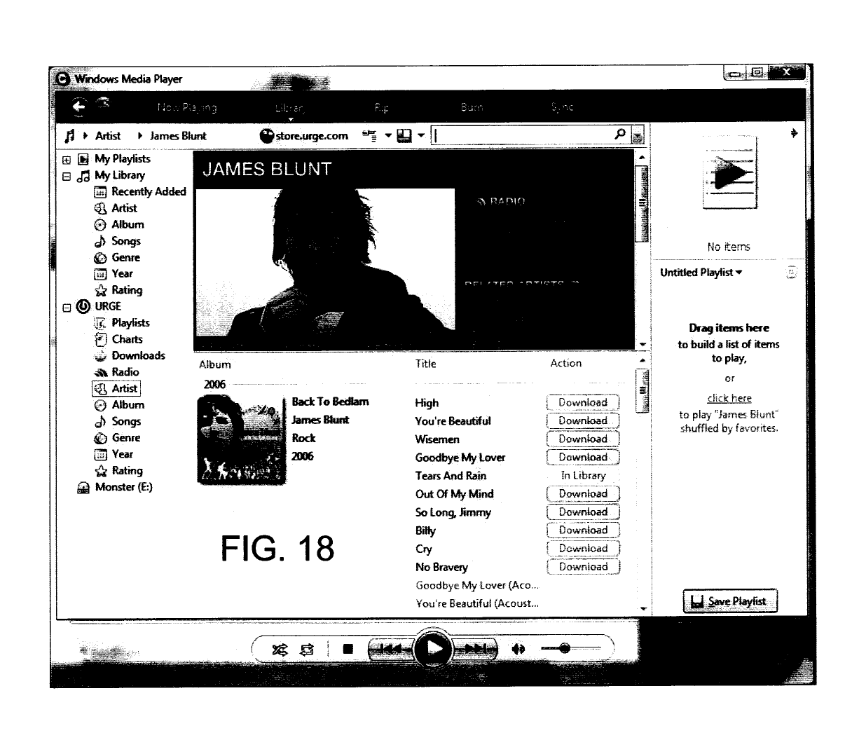

At 116 of FIG. 1C, if the user chose to drill down in the Artist's page in the Urge service results and then executed a query at 117 within the Artist>James Blunt scope for the song “Tears and Rain,” as shown in FIG. 17, then at 118 the view at FIG. 18 and at 118 of FIG. 1C of the Artist's songs would be filtered to show only those tracks matching the “Tears and Rain” query. The Search box dropdown would, in this case, update to reflect these results. In the case of the Urge catalog, the current scope, the results show that there were 9 matching Songs for this query. The User's local library is listed as an additional search scope with 1 match for “Tears and Rain” in the Local library context. Clicking on this Local result would return the user to the view shown in FIG. 14.

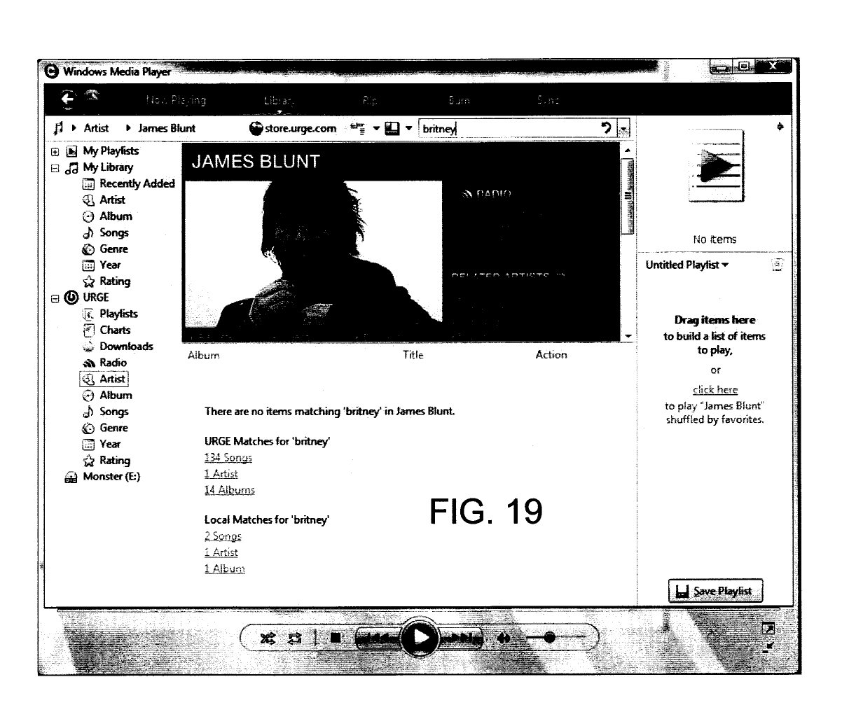

Once the user is satisfied with the search for the particular James Blunt song, they may wish to search for an additional track by a different artist. For example, let's assume at FIG. 19 the user wants to add Britney Spears' “Toxic” to a playlist. In this case, the user's current drilled-down view (Urge>Artist>James Blunt) does not affect the User's ability to find and act on this content. Clearing the Search control returns the User to an unfiltered view of James Blunt's songs. Typing in the query “Britney” into the Search control will cause a query for Britney in the current Artist>James Blunt scope. In this case, there are no matching query results in this drilled-down scope. However, the user is presented with a “no results” page at FIG. 19 and the results of expanded scope queries that have been executed.

In the case of the Artist Britney Spears, the User's query results in matches both in the expanded Urge scope, as well as their Local library. The ability to change the view based on the results of these background queries prevents the User from being “trapped” in a drilled-down limited scope (in this case, the Artist>James Blunt limited scope) while searching for a completely separate Artist, Britney Spears. In addition to the Urge results as shown, 2 songs, 1 Artist, and 1 Album match the query on the User's Local library.

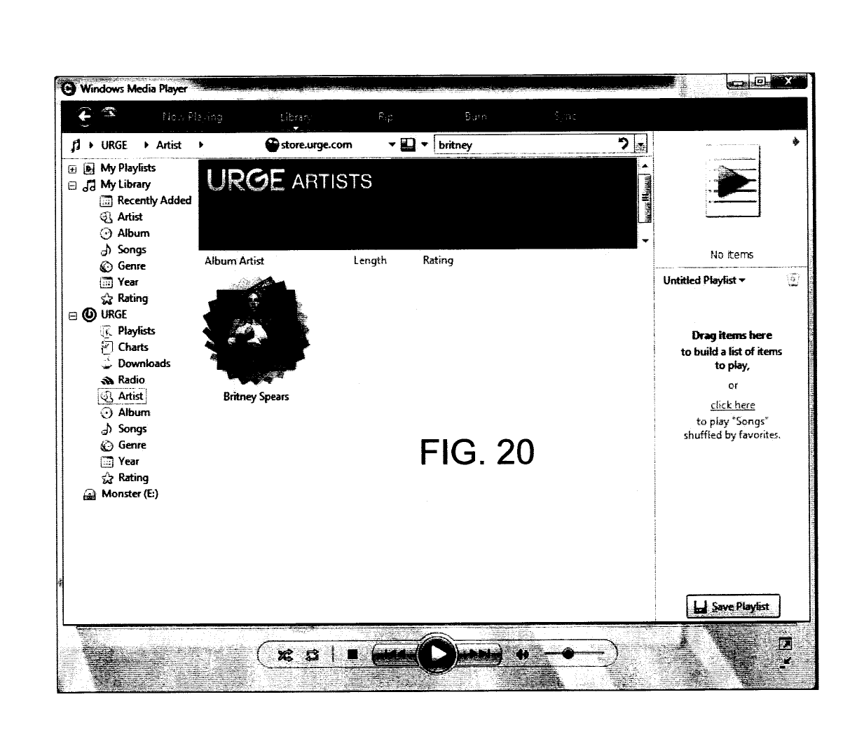

Assuming the User is searching for a particular song by Britney Spears, in this case “Toxic,” the User chooses to view the Artist's Urge page by clicking on the 1 Artist results match under the Urge Matches for ‘britney’ shown in FIG. 19, resulting in FIG. 20

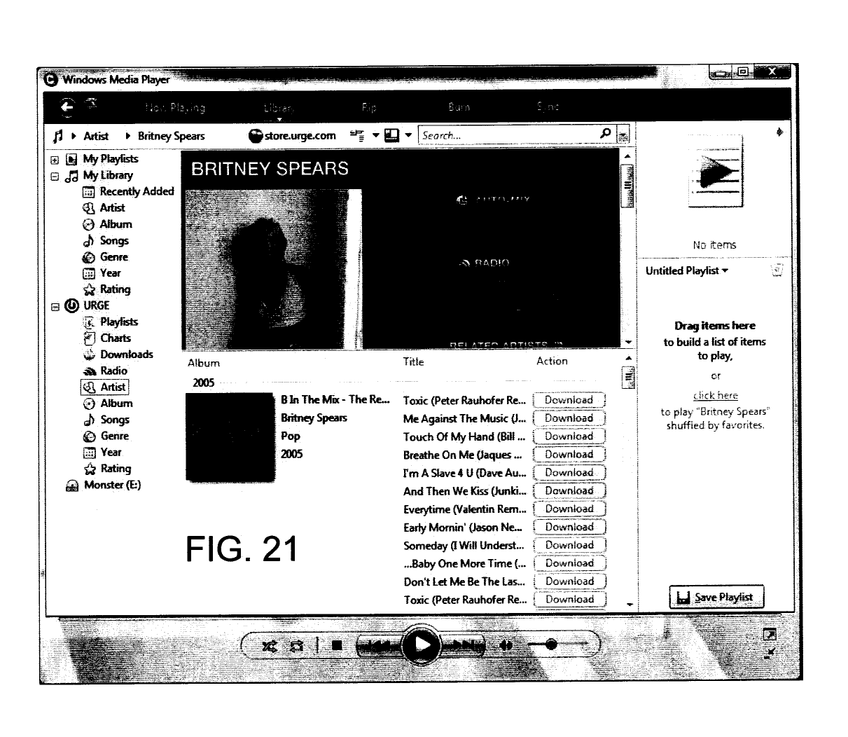

Having changed their view into another scope (in this case, the Urge>Artist>Britney Spears scope) the User can view Britney's available tracks on the Urge service at FIG. 21.

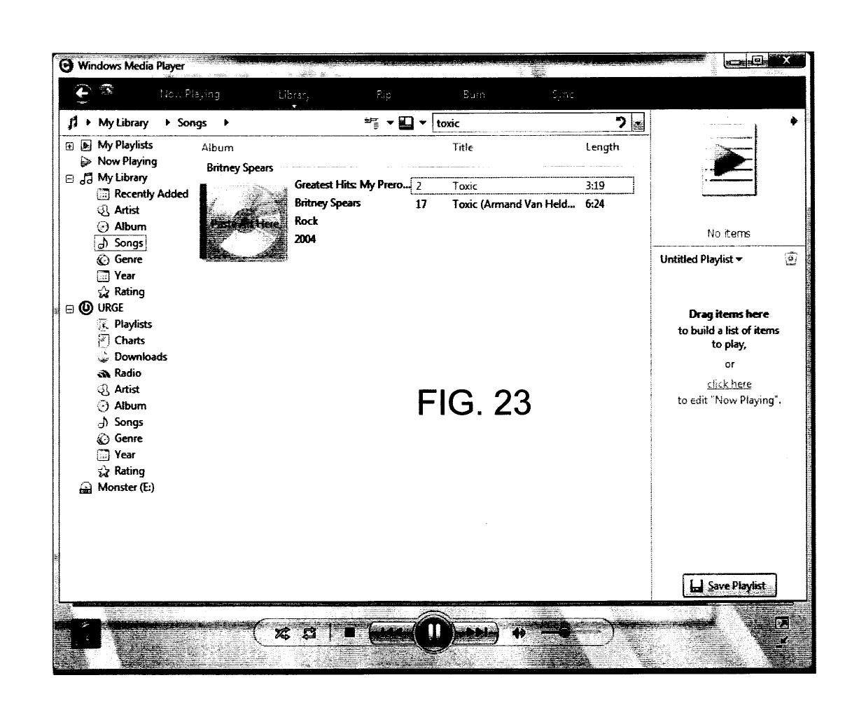

In this Artist>Britney Spears view, selecting the Search control and typing in a query for “Toxic” at FIG. 22 and at 122 of FIG. 1C will filter the view of Britney's songs. Having seen these Urge results, the User can also select the Search control drop-down menu to see additional search scopes. In this case, the query for Britney's Toxic on the Urge service will also result in background queries returning results for the User's Local library shown in FIG. 23. The query for “Toxic” produces 2 matches in “Songs” on the User's Local library. The User can switch their Library view to see these results by selecting the throbbing notifier FE, which is the My Library fly-out menu and navigating to the Songs (2) item. Upon selection of this item, the User is switched to their Local library, showing the 2 songs matching the “Toxic” query in their Local library.

FIG. 1B shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 1B illustrates operating system 144, application programs 146, other program modules 148, and program data 150.

The computer 130 may also include other removable/non-removable, volatile/nonvolatile computer storage media. For example, FIG. 1B illustrates a hard disk drive 154 that reads from or writes to non-removable, nonvolatile magnetic media. FIG. 1B also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 1B, provide storage of computer readable instructions, data structures, program modules and other data for the computer 130. In FIG. 1B, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 1B include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 1B illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. Aspects of the invention described herein includes these and other various types of computer-readable storage media when such media contain instructions or programs for implementing the steps described below in conjunction with a microprocessor or other data processor. Further, aspects of the invention include the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions such as those illustrated in the figures to implement aspects of the invention as illustrated in the figures.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A computer-implemented method of operation on a data processing device having access to a first data source of media items and having access to a second data source of media items, said method for generating in response to a user query of the first data source a list of media items, said method comprising:
in response to the user query of the first data source, searching the first data source and displaying information identifying one or more items, if any, of the first data source which identified items of the first data source correspond to the user query;
in response to the user query of the first data source, searching the second data source and displaying information identifying one or more items, if any, of the second data source which identified items of the second data source correspond to the user query.

2. The method of claim 1 wherein the first data source is a local library and wherein the second data source is one of the following: a media service, a network library or an Internet accessible library.

3. The method of claim 2 wherein the searching of the second data source is asynchronous relative to the searching of the first data source.

4. The method of claim 3 further comprising a notifier for indicating to the user that at least one item of the second data source has been identified as corresponding to the query.

5. The method of claim 1 wherein if the searching of the first data source yields no items, providing the user with the optional results of the search of the second data source.

6. The method of claim 1 wherein the searching of the second data source is asynchronous relative to the searching of the first data source.

7. The method of claim 1 further comprising a notifier for indicating to the user that at least one item of the second data source has been identified as corresponding to the query.

8. The method of claim 7 wherein the searching of the second data source is asynchronous relative to the searching of the first data source.

9. A computer-implemented method of operation on a data processing device having access to a first data source of media items and having access to a plurality of additional data sources of media items, said method for generating in response to a user query of the first data source a list of media items, said method comprising:
in response to the user query of the first data source, searching the first data source and displaying information identifying one or more items, if any, of the first data source which identified items of the first data source correspond to the user query;
in response to the user query of the first data source, searching at least one of the plurality of additional data sources and displaying information identifying one or more items, if any, found in the searching which identified items of the searched data source correspond to the user query.

10. The method of claim 9 wherein the first data source is a local library and wherein the second data source is at least one of the following: a media service, a network library or an Internet accessible library.

11. The method of claim 9 wherein the first data source is one of the following: a local library, a media service, a network library or an Internet accessible library and wherein the second data source is at least one of the following other than the first data source: a local library, a media service, a network library or an Internet accessible library.

12. The method of claim 9 wherein the searching of the second data source is asynchronous relative to the searching of the at least one of the plurality of additional data sources.

13. The method of claim 9 further comprising a notifier for indicating to the user that at least one item of the second data source has been identified as corresponding to the query.

14. The method of claim 9 wherein if the searching of the first data source yields no items, providing the user with the option to search the second data source.

15. A system for generating a list of media items, said system having access to a first data source of media items and a second data source of media items, said system comprising:
a user interface for receiving a user query for media items available from the first data source;
a processor for generating a first list of media items, if any, from the first data source in response to the user query;
said user interface for displaying the first list of items, if any, of the first data source;
said processor for generating a second list of media items, if any, from the second data source in response to the user query; and
said user interface for displaying the second list of items, if any, of the second data source.

16. The system of claim 15 wherein the first data source is a local library and wherein the second data source is one of the following: a media service, a network library or an Internet accessible library.

17. The system of claim 15 wherein the generating of the second list is asynchronous relative to the generating of the first list.

18. The system of claim 15 further comprising a notifier for indicating to the user that at least one item of the second data source has been identified as corresponding to the query.

19. The system of claim 15 wherein if the first list yields no items, the user is with optional results of the second list.

20. The system of claim 19 wherein the generating of the second list is asynchronous relative to the generating of the first list.
